(19) United States
(12) Patent Application Publication
(10) Pub. No.: US 2002/0174897 A1
(43) Pub. Date: Nov. 28, 2002

(54) Process for the storage and transport of chloroformic acid esters

(76) Inventors: Theodor Weber, Ludwigshafen (DE); Winfried Muller, Mannheim (DE); Stefan Rittinger, Mannheim (DE); Armin Stamm, Nieder-Olm (DE); Jochem Henkelmann, Mannheim (DE)

Correspondence Address: KEIL & WEINKAUF, 1350 CONNECTICUT AVENUE, N.W., WASHINGTON, DC, 20036, US

(21) Appl. No.: 10/041,559

(22) Filed: Jan. 10, 2002

(30) Foreign Application Priority Data
Jan. 23, 2001 (DE) 10102807.5

(51) Int. Cl. F16L 7/00

(52) U.S. Cl. 137/375

(57) ABSTRACT

A process for the storage and transport of chloroformic acid esters in tanks or pipelines which have a plastic inside surface, which comprises using a plastic having a total nitrogen content of from 0 to 100 ppm by weight, where this plastic forms from 20 to 100% of the inside surface, and the use of tanks or pipelines of this type for the storage and transport of chloroformic acid esters.

The present invention relates to a process for the storage and transport of chloroformic acid esters in tanks or pipelines which have a plastic inside surface, and to the use of such tanks or pipelines for the storage and transport of chloroformic acid esters.

Chloroformic acid esters, in particular the low-molecular-weight alkyl esters of chloroformic acid, are highly reactive intermediates in the preparation of agrochemicals and pharmaceuticals.

Chloroformic acid esters are obtainable on an industrial scale by reaction of the corresponding alcohols with phosgene. They are generally converted further into the corresponding secondary products at other locations, meaning that storage and transport are generally necessary.

Many chloroformic acid esters are classified as hazardous materials. The low-molecular-weight derivatives in particular exhibit toxic properties, are highly corrosive, in particular in the presence of moisture, owing to their tendency toward hydrolysis, and form explosive mixtures with air. In the presence of metal salts, metal oxides or various nitrogen-containing compounds, chloroformic acid esters tend to decompose, with formation of the corresponding alkyl chloride with elimination of carbon dioxide or with formation of the corresponding I-alkene with elimination of carbon dioxide and hydrogen chloride. Both reaction paths are described in Ullmann's Encyclopedia of Industrial Chemistry, 6th edition, 2000 Electronic Release, Chapter “CHLOROFORMIC ESTERS” and result in the formation of gaseous decomposition products.

Since the low-molecular-weight chloroformic acid esters in particular have an increased tendency toward decomposition and in addition these derivatives in particular are of particular technical relevance, and manufacturers and processors are generally separated by relatively large spatial distances, safe storage and transport is a very important point in handling these substances. In general, the chloroformic acid esters are transported and stored in relatively large tanks, usually rail tank cars, containers or drums. Owing to the high chemical reactivity, exclusively materials which are inert toward chloroformic acid esters must be used. For large tanks, for example rail tank cars or containers, enameled metals, for example enameled steel, are usually used. For relatively small amounts of, for example, one cubic meter or less, use is principally made of transport tanks which consist exclusively of plastic or are lined with plastic. In the case of the last-mentioned types, metal drums, for example, lined with so-called inliner materials or inliner films of plastic are usual. In general, the plastic used is polyethylene.

Since many plastics are light-sensitive and, in particular at elevated temperatures, oxygen-sensitive, stabilizers are usually added. This also applies to the abovementioned plastics usually employed. The added stabilizers are generally sterically hindered amines. Examples of frequently used stabilizers are mentioned in V. Ya. Shlyapintokh et al., “Antioxidant action of sterically hindered amines and related compounds” in “Developments in Polymer Stabilisation 5”, editor G. Scott, Applied Science Publishers, London/New Jersey 1982, pages 41 to 70 and J. Pospisil, “Activity Mechanisms of Amines in Polymer Stabilization” in “Polymer Durability”, editor R. L. Clough et al., Advances in Chemistry Series 249, 1993, pages 271 to 285. The stabilizers are usually added in amounts which give a total nitrogen content in the plastic of several hundred ppm by weight.

In particular in the case of tanks constructed for applications under atmospheric pressure or an only slight excess pressure, for example metal drums or plastic tanks, there is a particular risk of an excess pressure building up due to gradual decomposition of the chloroformic acid esters, which may represent a serious risk on opening of the tank or may even result in damage to the tank or even bursting. Experience in this area has shown that the normal commercial plastic tanks and metal drums with plastic inliners may result in a significant increase in pressure, especially on extended storage of the chloroformic acid esters.

Furthermore, the decomposition of the chloroformic acid esters results in the formation of decomposition products which contaminate the chloroformic acid esters.

It is an object of the present invention to find a process for the storage and transport of chloroformic acid esters which does not have the abovementioned disadvantages and in particular results in only extremely low levels of decomposition of the chloroformic acid esters, or none at all, and thus also results in only an extremely small increase in pressure, or none at all, even after extended storage for several months.

We have found that this object is achieved by a process for the storage and transport of chloroformic acid esters in tanks or pipelines which have a plastic inside surface, which comprises using a plastic having a total nitrogen content of from 0 to 100 ppm by weight, where this plastic forms from 20 to 100% of the inside surface.

The term “total nitrogen” is taken to mean the chemically bound nitrogen present in the plastic. Any molecular nitrogen (N₂) included in the plastic is not covered by this term. The chemically bound nitrogen may be in inorganic and/or organic form. It may be, for example, chemically bound in the polymer molecules or chemically bound in additives, for example stabilizers.

The total nitrogen content in the plastic is determined by the ASTM method D 6069-96 by pyrolysis, conversion of the nitrogen monoxide formed into activated nitrogen dioxide using ozone, and photometric quantitative measurement of the emitted light on transition into the ground state. This method determines inorganically and organically bound nitrogen. Molecular nitrogen (N₂) is not determined and is therefore likewise not included in the term “total nitrogen” used.

The process according to the invention uses a plastic which has a total nitrogen content of from 0 to 100 ppm by weight, preferably from 0 to 50 ppm by weight and particularly preferably from 0 to 20 ppm by weight. This forms from 20 to 100%, preferably from 50 to 100%, particularly preferably from 90 to 100% and very particularly preferably from 95 to 100%, in particular from 98 to 100%, of the inside surface in the process according to the invention. Any residual proportion of the inside surface that may be present, i.e. the remaining proportion to 100%, can be formed of other materials, for example plastics which do not satisfy said criterion with respect to the total nitrogen content (referred to below as “other plastics”), metals or alloys which are chemically inert to chloroformates, or glass.

The plastic employed particularly preferably has a content of less than 50 ppm by weight and very particularly preferably less than 20 ppm by weight of nitrogen in the form of compounds from the series consisting of secondary, tertiary or quaternary amines, for example 4-amino-2,2,6,6-tetramethylpiperidine and derivatives thereof, and N,N-dialkylformamides, for example N,N-dimethylformamide, N,N-diethylformamide, N,N-di-sec-butylformamide or N,N-diisobutylformamide.

Said plastics in the process according to the invention may be, for example, polymers based on one or different monomer(s) or mixtures of different polymers (so-called blends). The plastics may in principle be in crosslinked or uncrosslinked form. The essential factor is that said criterion with respect to the total nitrogen content is satisfied. The plastics used should advantageously be sufficiently chemically resistant to chloroformic acid esters that they are not decomposed by chloroformic acid esters and significant amounts of impurities are not released to the chloroformic acid esters. Furthermore, the plastics used should have only extremely low permeability to chloroformic acid esters, or none at all. Examples of suitable plastics which may be mentioned are polyolefins or halogenated polyolefins (for example polytetrafluoroethylene, for example Teflon® or vinylidene fluoride-hexafluoropropylene copolymers, for example Viton®).

The plastic preferably used in the process according to the invention is a polyolefin. The term polyolefin is taken to mean polymers built up essentially from [—CH₂—CR¹R²—] units, where R¹ and R², independently of one another, are hydrogen, a straight-chain or branched, saturated aliphatic or cycloaliphatic group. The polyolefin molecules may be in crosslinked or uncrosslinked form. Furthermore, the polyolefin may also comprise additives. The polyolefin may thus, for example, (i) be based purely on one and the same monomer (for example “pure polyethylene” or “pure polypropylene”), (ii) be based on different monomers (for example “polyethylene-propylene copolymer” or copolymers of ethylene or propylene with relatively long-chain olefins, for example 1-butene or 1-hexene and/or dienes, such as 1,3-butadiene or 1,5-hexadiene), or (iii) comprise various polyolefins (for example blends of various polyolefins). Without representing a limitation, examples of suitable polyolefins which may be mentioned are polyethylenes, polypropylenes and “polyethylene-propylene copolymers”. The terms “polyethylene”, “polypropylene” and “polyethylene-propylene copolymer” also include, in particular, polyolefins obtained by copolymerization with relatively long-chain olefins, for example 1-butene or 1-hexene and/or dienes, such as 1,3-butadiene or 1,5-hexadiene.

The plastic particularly preferably used in the process according to the invention is polyethylene. Examples of suitable polyethylenes which may be mentioned are PE-LD (low density), PE-LLD (linear low density), PE-HD (high density) and PE-MD (middle density). very particular preference is given to PE-HD. The PE-HD which is very particularly preferred in the process according to the invention preferably comprises less than 50 ppm by weight, very particularly preferably less than 20 ppm by weight and in particular less than 10 ppm by weight of nitrogen in the form of compounds from the series consisting of secondary, tertiary or quaternary amines, for example 4-amino-2,2,6,6-tetramethylpiperidine and derivatives thereof, and N,N-dialkylformamides, for example N,N-dimethylformamide, N, N-diethylformamide, N, N-di-sec-butylformamide or N,N-diisobutylformamide.

The size of the tank is generally not significant for the process according to the invention. It is possible to employ small tanks, for example having a volume in the μl or ml range, medium-sized tanks, for example in the 1 range, and also large tanks, for example in the m³ range, and sizes in between.

The geometrical shape of the tanks is also generally insignificant for the process according to the invention. Examples which may be mentioned are (i) essentially spherical tanks (so-called sphere tanks), (ii) essentially cylindrical tanks (for example bottles, drums, so-called cylinder tanks, rail tank cars, reactors or separators) and (iii) essentially cubic or cuboid tanks (for example containers).

The tanks or pipelines may, for example, essentially or even completely consist of said plastic. Examples of tanks are bottles or drums made from said plastic, or containers, if desired with external metal braces. The closures of said tanks preferably likewise predominantly consist of this plastic, where any seals necessary may also comprise or consist of other materials.

Furthermore, the tanks or pipelines may also be constructed in the form of a two-layer or multilayer structure. Thus, the outer layer or the outer part generally predominantly serves for satisfying the mechanical requirements. The outer layer or outer part may likewise comprise said plastic, “another plastic”, a metallic, ceramic or mineral material, glass or combinations of these substances. The inside surface is formed from said plastic in the abovementioned proportion. This can be, for example, in the form of a film, a so-called inliner or another lining, for example by plastic moldings placed against one another. Preferred examples of tanks are drums made from metal, said plastic or “another plastic”, which are lined with a film of said plastic or contain a so-called inliner made from this plastic. Furthermore, mention may also be made of tanks or pipelines which are lined with a film or moldings of said plastic or tanks which contain a so-called inliner made from this plastic. The closures of said tanks can generally comprise or consist of different materials, for example “other plastics” or metals. They preferably likewise predominantly consist of said plastic, where any seals necessary may also comprise or consist of other materials.

The process according to the invention is preferably carried out using tanks, in particular in the form of bottles, drums and containers.

The terms storage and transport explicitly also include handling in plants and apparatuses for production or further processing of chloroformic acid esters.

The chloroformic acid esters which can be employed in the process according to the invention have the general formula (I)

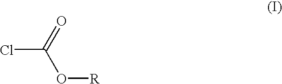

where R is a carbon-containing organic radical.

The term carbon-containing organic radical is taken to mean an unsubstituted or substituted, aliphatic, aromatic or araliphatic radical having 1 to 20 carbon atoms. This radical may contain one or more heteroatoms, for example oxygen, nitrogen or sulfur, for example —O—, —S—, —NR—, —CO— and/or —N═ in aliphatic or aromatic systems, and/or be substituted by one or more functional groups, which contain, for example, oxygen, nitrogen, sulfur and/or halogen, for example by fluorine, chlorine, bromine, iodine and/or a cyano group. Preferred examples of the carbon-containing organic radical which may be mentioned are C₁- to C₂₀-alkyl, particularly preferably C₁- to C₈-alkyl (for example methyl, ethyl, 1-propyl, 2-propyl, 1-butyl, 2-butyl, 2-methyl-1-propyl, 2-methyl-2-propyl, 1-pentyl, 1-hexyl, 1-octyl or 2-ethyl-1-hexyl), C₆- to C₁₀-aryl, particularly preferably phenyl, C₇- to C₁₀-aralkyl, particularly preferably phenylmethyl, and C₇-to C₁₀-alkaryl, particularly preferably 2-methylphenyl, 3-methylphenyl and 4-methylphenyl.

In the process according to the invention, very particular preference is given to the storage and transport of C₁- to C₄-alkyl chloroformates, specifically methyl chloroformate, ethyl chloroformate, 1-propyl chloroformate, 2-propyl chloroformate, 1-butyl chloroformate, 2-butyl chloroformate and 2-methyl-1-propyl chloroformate, in particular methyl chloroformate and ethyl chloroformate.

The chloroformic acid esters can be stored or transported in undiluted form, for example having a content of ≧99% by weight, or in diluted form in a solvent or in a reaction medium. The process according to the invention is preferably used for the storage and transport of undiluted chloroformic acid esters.

In a preferred embodiment, the chloroformic acid ester is stored and transported in a polyethylene bottle, where the polyethylene has a total nitrogen content of from 0 to 100 ppm by weight.

In another preferred embodiment, the chloroformic acid ester is stored and transported in a metal drum having a so-called inliner of polyethylene, where the polyethylene has a total nitrogen content of from 0 to 100 ppm by weight.

In a further preferred embodiment, the chloroformic acid ester is stored and transported in a polyethylene container, where the polyethylene has a total nitrogen content of from 0 to 100 ppm by weight.

The invention furthermore relates to the use of tanks or pipelines in accordance with the above-described process according to the invention for the storage and transport of chloroformic acid esters.

The process according to the invention and the use according to the invention are surprising in many respects. Firstly, it is amazing that the stabilizers added to the plastic composition in small amounts are able to develop any chemical action against the chloroformic acid esters at all.

Secondly, no general behavior of chloroformic acid esters against nitrogen compounds can be derived from the prior art. Thus, for example, G. Heywang, “Kohlensäure-ester-halogenide” in Houben-Weyl, 4th Edition, Volume E4 “Kohlensäurederivate”, G. Thieme Verlag, Stuttgart 1983, pages 13 to 14, describes the complete decomposition of methyl chloroformate by small amounts of N,N-dimethylformamide at 20° C. within six weeks to give chloromethane and carbon dioxide. DE-A 22 01 433, by contrast, describes the stabilization of chlorocarbonic acid esters (chloroformic acid esters) by addition of amides. JP-A J5 0121-212 also discloses the stabilization of chloroformic acid esters by addition of amides. Furthermore, J5 0121-212 also teaches stabilization in the presence of tertiary amines, for example N,N-dimethylaniline or tributylamine.

The process according to the invention and the use according to the invention enable the storage and transport of chloroformic acid esters in tanks or pipelines, with only an extremely small amount of decomposition of the chloroformic acid ester, or none at all, taking place even after extended storage for a number of months or even a number of years. Since the chloroformic acid ester is only contaminated with the composition products to an extremely small extent, or not at all, the product quality is thereby retained. In addition, the only extremely small or zero pressure increase now present in the tank also results in a significant increase in safety.

### EXAMPLES

Procedure For Experiments 1 to 8

About 250 ml of the chloroformic acid ester were introduced into a glass vessel with about 1.4 g of the stamped-out plastic sample (total geometrical surface area about 5 to 10 cm², and the vessel is sealed and stored at 40° C. Reference experiments 4 and 8 were carried out without addition of a plastic sample. After various times, liquid samples were taken and analyzed by gas chromatography for their content of chloroformic acid ester. Furthermore, where appropriate, the chloroalkane content was determined by gas chromatography and the APHA color number was measured (in accordance with DIN 6271).

Characterization of plastics A to C employed

The three plastics shown in Table 1 were employed.

TABLE 1

| | | Total | Total | Total |
|---|---|---|---|---|
| | | nitrogen | sulfur | phosphorus |
| | Plastic | [ppm by wt.] | [ppm by wt.] | [ppm by wt.] |
| A* | Polyethylene | 320 | 4 | 37 |
| | (PE—HD) | | | |
| B* | Polyethylene | 280 | 3 | 34 |
| | (PE—HD) | | | |
| C | Polyethylene | 8 | 4 | 35 |
| | (PE—HD) | | | |

*for comparative example

### EXAMPLES 1 to 4

### Storage Stability of Methyl Chloroformate

The storage stability of methyl chloroformate in the presence of the three plastics A, B and C was investigated in accordance with the procedure described above. The results are shown in Tables 2a and 2b.

TABLE 2a
Content of methyl chloroformate in % by weight.

| | | | After | After | After |
|---|---|---|---|---|---|
| Example | Plastic | Zero sample | 6 weeks | 3 months | 6 months |
| 1* | A | 99.81 | 98.36 | 96.64 | 94.37 |
| 2* | B | 99.81 | 98.36 | 97.09 | 94.18 |
| 3 | C | 99.81 | 99.81 | 99.76 | 99.68 |
| 4** | — | 99.81 | 99.80 | 99.75 | 99.69 |

*Comparative example
**Reference sample without addition of plastic

TABLE 2b
Content of chloromethane in % by weight.

| | | | After | After | After |
|---|---|---|---|---|---|
| Example | Plastic | Zero sample | 6 weeks | 3 months | 6 months |
| 1* | A | <0.01 | 1.08 | 2.30 | 4.69 |
| 2* | B | <0.01 | 1.00 | 2.08 | 4.88 |
| 3 | C | <0.01 | <0.01 | <0.01 | <0.01 |
| 4** | — | <0.01 | <0.01 | <0.01 | <0.01 |

*Comparative Example
**Reference sample without addition of plastic

### EXAMPLES 5 to 8

### Storage Stability of Ethyl Chloroformate

The storage stability of ethyl chloroformate was investigated in the presence of the three plastics A, B and C in accordance with the procedure described above. The results are shown in Tables 3a and 3b.

TABLE 3a
Content of ethyl chloroformate in % by weight.

| | | | After | After | After |
|---|---|---|---|---|---|
| Example | Plastic | Zero sample | 6 weeks | 3 months | 6 months |
| 5* | A | 99.49 | 99.50 | 99.43 | 99.19 |
| 6* | B | 99.49 | 99.49 | 99.42 | 99.21 |
| 7 | C | 99.49 | 99.52 | 99.49 | 99.43 |
| 8** | — | 99.49 | 99.53 | 99.49 | 99.45 |

*Comparative Example
**Reference sample without addition of plastic

plastic

TABLE 3b
APHA color number.

| | | | After | After | After |
|---|---|---|---|---|---|
| Example | Plastic | Zero sample | 6 weeks | 3 months | 6 months |
| 5* | A | 9 | 15 | 19 | 28 |
| 6* | B | 9 | 13 | 17 | 21 |
| 7 | C | 9 | 9 | 9 | 9 |
| 8** | — | 9 | 8 | 6 | 7 |

*Comparative Example
**Reference sample without addition of plastic

plastic

Comparative Examples 1* and 2* and also 5* and 6* show that decomposition of the chloroformic acid ester occurs in the presence of the stabilized plastics A and B, which have a total nitrogen content of 320 ppm by weight and 280 ppm by weight respectively. It can be seen from Examples 1* and 2* that significant contamination with the degradation product chloromethane occurs in parallel to the decomposition of the methyl chloroformate. Examples 5* and 6* show a clearly measurable increase in the APHA color number.

By contrast, virtually no decomposition takes place in the presence of a plastic having a total nitrogen content of 8 ppm by weight, as confirmed by Examples 3 and 7 according to the invention. The analytical data obtained are more or less identical with those of the reference sample without addition of plastic. This confirms that the plastics employed in the process according to the invention have a very inert surface which is comparable with a glass surface.

The following examples confirm the decomposition of the chloroformic acid esters in the presence of amines and amides.

Procedure For Experiments 9 to 32

99.99 g of the chloroformic acid ester were introduced into a 100 ml glass bottle. 0.01 g of diisobutylformamide (“DIBF”) was added in Experiments 13, 14, 19 and 20, and 0.01 g of 4-amino-2,2,6,6-tetramethylpiperidine (“ATMP”) was added in Experiments 25, 26, 31 and 32. With the exception of reference experiments 9, 10, 15, 16, 21, 22, 27 and 28, about 1.4 g of the stamped-out plastic sample of type “C” (total geometrical surface area about 5 to 10 cm²) were further added. The glass bottles were stored sealed at 40° C. After 8 weeks, a liquid sample was taken in each case and analyzed by gas chromatography with respect to its content of chloroformic acid ester and chloroalkane.

### EXAMPLES 9 TO 20

### Effect of N,N-diisobutylformamide

The effect of N,N-diisobutylformamide on the decomposition of methyl chloroformate and ethyl chloroformate was investigated in accordance with the procedure described above. The results are shown in Tables 4a and 4b as well as 5a and 5b.

TABLE 4a
Content of methyl chloroformate in GC area-%.

| | | “DIBF” | Zero | After |
|---|---|---|---|---|
| Example | Plastic | [ppm by wt. of N] | sample | 8 weeks |
| 9** | — | — | 99.70 | 99.69 |
| 10** | — | — | 99.70 | 99.70 |
| 11 | C | — | 99.70 | 99.68 |
| 12 | C | — | 99.70 | 99.70 |
| 13 | C | 9 | 99.70 | 97.70 |
| 14 | C | 9 | 99.70 | 97.58 |

**Reference sample without addition of plastic

TABLE 4b
Content of chloromethane in GC area-%.

| | | “DIBF” | Zero | After |
|---|---|---|---|---|
| Example | Plastic | [ppm by wt. of N] | sample | 8 weeks |
| 9** | — | — | <0.01 | <0.01 |
| 10** | — | — | <0.01 | <0.01 |
| 11 | C | — | <0.01 | <0.01 |
| 12 | C | — | <0.01 | <0.01 |
| 13 | C | 9 | <0.01 | 1.32 |
| 14 | C | 9 | <0.01 | 1.40 |

**Reference sample without addition of plastic

TABLE 5a
Content of ethyl chloroformate in GC area-%.

| | | “DIBF” | Zero | After |
|---|---|---|---|---|
| Example | Plastic | [ppm by wt. of N] | sample | 8 weeks |
| 15** | — | — | 99.54 | 99.45 |
| 16** | — | — | 99.54 | 99.40 |
| 17 | C | — | 99.54 | 99.45 |
| 18 | C | — | 99.54 | 99.42 |
| 19 | C | 9 | 99.54 | 98.54 |
| 20 | C | 9 | 99.54 | 98.74 |

**Reference sample without addition of plastic

TABLE 5b
Content of chloroethane in GC area-%.

| | | “DIBF” | Zero | After |
|---|---|---|---|---|
| Example | Plastic | [ppm by wt. of N] | sample | 8 weeks |
| 15** | — | — | 0.006 | 0.02 |
| 16** | — | — | 0.006 | 0.02 |
| 17 | C | — | 0.006 | 0.02 |
| 18 | C | — | 0.006 | 0.03 |
| 19 | C | 9 | 0.006 | 0.66 |
| 20 | C | 9 | 0.006 | 0.51 |

**Reference sample without addition of plastic

In experiments 13, 14, 19 and 20 with addition of “DIBF”, a pressure cushion built up in the glass bottle within the storage time and was released on opening.

Examples 13, 14, 19 and 20 show that significant decomposition of the alkyl chloroformate employed with formation of chloroalkane is introduced even on addition of 9 ppm by weight of nitrogen in the form of N,N-diisobutylformamide.

### EXAMPLES 21 TO 32

### Effect of 4-amino-2,2,6,6-tetramethylpiperidine

The effect of 4-amino-2,2,6,6-tetramethylpiperidine on the decomposition of methyl chloroformate and ethyl chloroformate was investigated in accordance with the procedure described above. The results are shown in Tables 6a and 6b as well as 7a and 7b.

TABLE 6a
Content of methyl chloroformate in GC area-%.

| | | “ATMP” | Zero | After |
|---|---|---|---|---|
| Example | Plastic | [ppm by wt. of N] | sample | 8 weeks |
| 21** | — | — | 99.70 | 99.69 |
| 22** | — | — | 99.70 | 99.70 |
| 23 | C | — | 99.70 | 99.68 |
| 24 | C | — | 99.70 | 99.70 |
| 25 | C | 18 | 99.70 | 99.69 |
| 26 | C | 18 | 99.70 | 99.68 |

**Reference sample without addition of plastic

TABLE 6b
Content of chloromethane in GC area-%.

| | | “ATMP” | Zero | After |
|---|---|---|---|---|
| Example | Plastic | [ppm by wt. of N] | sample | 8 weeks |
| 21** | — | — | <0.01 | <0.01 |
| 22** | — | — | <0.01 | <0.01 |
| 23 | C | — | <0.01 | <0.01 |
| 24 | C | — | <0.01 | <0.01 |
| 25 | C | 18 | <0.01 | 0.031 |
| 26 | C | 18 | <0.01 | 0.033 |

**Reference sample without addition of plastic

TABLE 7a
Content of ethyl chloroformate in GC area-%.

| | | “ATMP” | Zero | After |
|---|---|---|---|---|
| Example | Plastic | [ppm by wt. of N] | sample | 8 weeks |
| 27** | — | — | 99.54 | 99.45 |
| 28** | — | — | 99.54 | 99.40 |
| 29 | C | — | 99.54 | 99.45 |
| 30 | C | — | 99.54 | 99.42 |
| 31 | C | 18 | 99.54 | 99.40 |
| 32 | C | 18 | 99.54 | 99.49 |

**Reference sample without addition of plastic

TABLE 7b
Content of chloroethane in GC area-%.

| | | “ATMP” | Zero | After |
|---|---|---|---|---|
| Example | Plastic | [ppm by wt. of N] | sample | 8 weeks |
| 27** | — | — | 0.01 | 0.02 |
| 28** | — | — | 0.01 | 0.02 |
| 29 | C | — | 0.01 | 0.02 |
| 30 | C | — | 0.01 | 0.03 |
| 31 | C | 18 | 0.01 | 0.03 |
| 32 | C | 18 | 0.01 | 0.03 |

**Reference sample without addition of plastic

Some of the “ATMP” employed remained as an insoluble sediment.

Examples 25 and 26 show that already measurable decomposition of methyl chloroformate with formation of chloromethane is induced by addition of 18 ppm by weight of nitrogen in the form of 4-amino-2,2,6,6-tetramethylpiperidine. In the case of ethyl chloroformate, no effect is evident under otherwise identical conditions in this concentration range (see Examples 31 and 32).

Procedure For Experiments 33 to 44

99.95 g of the chloroformic acid ester were introduced into a 100 ml glass bottle. In experiments 37, 38, 43 and 44, 0.05 g of 4-amino-2,2,6,6-tetramethylpiperidine (“ATMP”) were added. With the exception of reference experiments 33, 34, 39 and 40, about 1.4 g of the stamped-out plastic sample of type “C” (total geometrical surface area from about 5 to 10 cm²) were further added. The glass bottles were sealed and stored at 40° C. After 14 weeks, a liquid sample was taken from each bottle and analyzed by gas chromatography with respect to its content of chloroformic acid ester and chloroalkane.

### EXAMPLES 33 TO 44

### Effect of 4-amino-2,2,6,6-tetramethyl-piperidine

The influence of 4-amino-2,2,6,6-tetramethylpiperidine on the decomposition of methyl chloroformate and ethyl chloroformate was investigated in accordance with the procedure described above. The results are summarized in Tables 8a and 8b and 9a and 9b.

TABLE 8a
Content of methyl chloroformate in GC area-%.

| | | “ATMP” | Zero | After |
|---|---|---|---|---|
| Example | Plastic | [ppm by wt. of N] | sample | 8 weeks |
| 33** | — | — | 99.68 | 99.52 |
| 34** | — | — | 99.68 | 99.52 |
| 35 | C | — | 99.68 | 99.55 |
| 36 | C | — | 99.68 | 99.53 |
| 37 | C | 90 | 99.68 | 99.15 |
| 38 | C | 90 | 99.68 | 99.15 |

**Reference sample without addition of plastic

TABLE 8b
Content of chloromethane in GC area-%.

| | | “ATMP” | Zero sample | After |
|---|---|---|---|---|
| Example | Plastic | [ppm by wt. of N] | 14 weeks | |
| 33** | — | — | <0.01 | <0.01 |
| 34** | — | — | <0.01 | <0.01 |
| 35 | C | — | <0.01 | <0.01 |
| 36 | C | — | <0.01 | <0.01 |
| 37 | C | 90 | <0.01 | 0.26 |
| 38 | C | 90 | <0.01 | 0.30 |

**Reference sample without addition of plastic

TABLE 9a
Content of ethyl chloroformate in GC area-%.

| | | “ATMP” | Zero sample | After |
|---|---|---|---|---|
| Example | Plastic | [ppm by wt. of N] | 14 weeks | |
| 39** | — | — | 99.52 | 99.18 |
| 40** | — | — | 99.52 | 99.16 |
| 41 | C | — | 99.52 | 99.16 |
| 42 | C | — | 99.52 | 99.17 |
| 43 | C | 90 | 99.52 | 99.29 |
| 44 | C | 90 | 99.52 | 99.03 |

**Reference sample without addition of plastic

TABLE 9b
Content of chloroethane in GC area-%.

| | | “ATMP” | Zero sample | After |
|---|---|---|---|---|
| Example | Plastic | [ppm by wt. of N] | 14 weeks | |
| 39** | — | — | <0.01 | 0.06 |
| 40** | — | — | <0.01 | 0.07 |
| 41 | C | — | <0.01 | 0.06 |
| 42 | C | — | <0.01 | 0.06 |
| 43 | C | 90 | <0.01 | 0.08 |
| 44 | C | 90 | <0.01 | 0.07 |

**Reference sample without addition of plastic

Some of the “ATMP” employed remained as an insoluble sediment.

Examples 37 and 38 show that addition of 90 ppm by weight of nitrogen in the form of 4-amino-2,2,6,6-tetramethylpiperidine induces a mesurable decomposition of methyl chloroformate with formation of chloromethane. In the case of ethyl chloroformate, a tendency toward decomposition is observable under otherwise identical conditions in this concentration range, which is evident from the up to 33% higher contents of chloroethane compared with Examples 41 and 42 without addition of “ATMP” (see Examples 43 and 44).

We claim:

1. A process for the storage and transport of chloroformic acid esters in tanks or pipelines which have a plastic inside surface, which comprises using a plastic having a total nitrogen content of from 0 to 100 ppm by weight, where this plastic forms from 20 to 100% of the inside surface.

2. A process as claimed in claim 1, wherein this plastic forms from 90 to 100% of the inside surface.

3. A process as claimed in claim 1, wherein this plastic forms from 95 to 100% of the inside surface.

4. A process as claimed in claim 1, wherein a plastic having a total nitrogen content of from 0 to 50 ppm by weight is used.

5. A process as claimed in claim 1, wherein the plastic used is a polyolefin.

6. A process as claimed in claim 5, wherein the plastic used is a polyethylene.

7. A process as claimed in claim 1, wherein C₁- to C₄-alkyl chloroformates are stored or transported.

8. A method of using tanks or pipelines in accordance with a process as claimed in claim 1 for the storage and transport of chloroformic acid esters.
